(19) United States
(12) Patent Application Publication
(10) Pub. No.: US 2014/0245192 A1
(43) Pub. Date: Aug. 28, 2014

(54) PORTABLE AND CONTEXT SENSITIVE AVATAR METHODS AND SYSTEMS

(71) Applicant: AVAYA INC., Basking Ridge, NJ (US)

(72) Inventor: David L. Chavez, Broomfield, CO (US)

(73) Assignee: AVAYA INC., Basking Ridge, NJ (US)

(21) Appl. No.: 13/777,607

(22) Filed: Feb. 26, 2013

(51) Int. Cl. G06F 3/0481

(52) U.S. Cl. CPC G06F 3/04815
USPC 715/757

(57) ABSTRACT

Methods and systems for providing avatars in a virtual reality environment (VRE) are provided. More particularly, different avatars can be defined for application to different VREs. A particular avatar can be selected or modified for application to a VRE in view of the context of the VRE, including but not limited to the avatar format required by the VRE, the topic of a meeting hosted by the VRE, the identity or other characteristics of other meeting participants, presence information, or the like.

### FIELD

Methods and systems for providing a portable and/or context sensitive avatar are described. More particularly, methods and systems that allow an avatar to be portable between and/or equipped with different characteristics for different virtual reality environments are provided.

### BACKGROUND

Meetings can be a very important part of doing business. With good planning, participation, and follow-up, meetings can help move a project or decision forward or bring people to consensus. One of the benefits to having people in one place is the ability to read body language and to ascertain other non-verbal information provided by other meeting participants. Various types of media attempt to address this when face to face meetings aren't possible. For example, enterprises can use videoconferencing to simulate face to face communications, without losing all of the possible non-verbal information. In addition, virtual reality environments (VREs) have been developed that allow users to interact with one another through physical representations of the participants in the form of avatars, and to share information in a shared space.

In a virtual reality conference or other virtual reality environment (VRE), users interact with one another within a virtual meeting space. More particularly, individual users can be represented as avatars in the virtual meeting space. The characteristics of an avatar associated with a particular user can be selected to represent the real or desired attributes of that user to other VRE participants. When a user participates in different VREs, that user must typically define an avatar for each different VRE. Moreover, the creation of an avatar for different VREs usually requires that the user create a new avatar for each VRE, as avatars are typically not portable between VREs. In addition, users often would like to present different or modified personas in different VRE contexts. However, doing so has required that the user manually revise the characteristics of their avatar. As a result, the use of different avatars for different VREs or VRE contexts has been limited. Accordingly, it would be desirable to provide methods and systems that facilitate the definition and selection of avatars for use in connection with VREs.

### SUMMARY

Methods and systems for providing a portable and/or context sensitive avatar are described. More particularly, a user can define an avatar for use in a virtual reality environment (VRE). The defined avatar may comprise a basic avatar. In addition to the basic avatar, the user can define different avatars for use in different VREs and/or different contexts. The particular avatar or avatar characteristics applied in a particular VRE or context can be user selected. Alternatively or in addition, the avatar or avatar characteristics can be determined by or with reference to the VRE, and/or by or with reference to other participants in a VRE.

In accordance with at least some embodiments, an avatar application and a data store are provided that are capable of receiving user input defining the characteristics of an avatar for use in connection with one or more VREs. The user can also define alternate avatar characteristics. The alternate characteristics can be embodied in alternate avatars or as modifications that are applied to a base or standard avatar for the user. The avatar application and data store can be implemented as part of a user computer, a server computer, a VRE server, or a combination of various devices.

Methods in accordance with embodiments of the present disclosure include defining a first set of characteristics of a first avatar associated with a first user, and applying the first set of characteristics to a first implementation of the first avatar in a first interactive computing environment or VRE. Such methods can additionally include applying some or all of the first set of characteristics to a second implementation of the first avatar in a second VRE. For example, the first implementation of the first avatar defined by the first set of characteristics can be formatted or coded for compatibility with the first interactive computing environment, while the second implementation of the first avatar defined by the first set of characteristics can be formatted or coded for compatibility with the second interactive computing environment. Alternatively or in addition, a second avatar with a second set of characteristics can be defined for the first user that includes at least a portion of the first set of characteristics of the first avatar. For example, the first set of characteristics defining the first avatar can be altered to define the second avatar. In accordance with still other embodiments, different user avatars or avatar characteristics can be selected for use in different VREs or VRE contexts. For example, a different avatar or a different set of avatar characteristics can be used for VREs with different meeting topics, or different participant rosters.

Additional features and advantages of embodiments of the present invention will become more readily apparent from the following description, particularly when taken together with the accompanying drawings.

### BRIEF DESCRIPTION OF THE DRAWINGS

FIG. 1 depicts components of a system in accordance with embodiments of the present disclosure;

FIG. 2A depicts components of a virtual reality server in accordance with embodiments of the present disclosure;

FIG. 2B depicts components of a user communication device in accordance with embodiments of the present disclosure;

FIG. 3A depicts an example virtual reality environment in accordance with embodiments of the present disclosure;

FIG. 3B depicts an example virtual reality environment in accordance with embodiments of the present disclosure;

FIG. 3C depicts an example virtual reality environment in accordance with embodiments of the present disclosure;

FIG. 3D depicts an example virtual reality environment in accordance with embodiments of the present disclosure; and

FIG. 4 is a flowchart depicting aspects of a method for providing a portable or context sensitive avatar in accordance with embodiments of the present disclosure.

### DETAILED DESCRIPTION

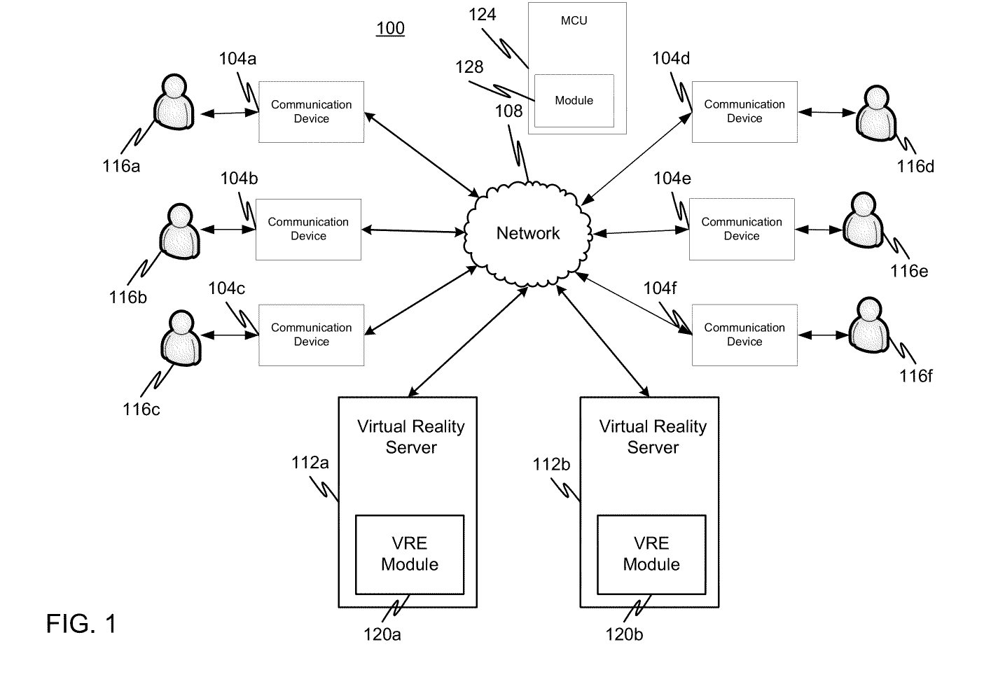

FIG. 1 is a block diagram depicting components of a communication system 100 in accordance with embodiments of the present disclosure. In general, the system 100 includes a plurality of user communication devices (hereinafter communication devices) 104 interconnected by one or more networks 108 to one or more virtual reality (VR) servers 112. In general, a VR server 112 operates to present a virtual reality environment (VRE) to at least some of the users 116 associated with the communication devices 104. In addition, stored data and programming on the communication devices 104 and/or the virtual reality servers 112 provides an avatar depicting individual users 116 within a VRE. When the system 100 includes multiple VR servers 112, different VR servers 112 may comprise different computing environments that require different data formats for user 116 avatars. In accordance with at least some embodiments, the communication system 100 additionally includes a conference server or multipoint control unit (MCU) 124.

A communication device 104 generally supports communications between a user 116 of the communication device 104 and a user 116 of another communication device 104. Examples of communication devices 104 include desktop computers, laptop computers, tablet computers, thin client devices, smart phones, and the like. Communications including one or more communication devices 104 can be conducted within a VRE provided by a VR server 112. In addition, embodiments of the present disclosure allow a user to define the characteristics of one or more avatars that can be applied in different VREs. More particularly, through a communication device 104, a user 116 can define one or more avatars and characteristics associated with such avatars for use in one or more VREs. In addition, the defined avatar or avatars can be stored on the communication device 104 and/or an associated device for selective application by the user 116. In accordance with still other embodiments of the present disclosure, the characteristics of a user's 116 avatar can be modified depending on the characteristics of the particular VRE in which the avatar is utilized. For example, as described in greater detail elsewhere herein, the subject matter of a meeting taking place in connection with a VRE, the identity of one or more other participants in the meeting, actual presence data, virtual presence data, time of day, day of the week, season, or any other parameter can be applied as a factor that modifies the characteristics of an avatar.

The communication network 108 may be any type of network that supports communications using any of a variety of protocols. For example, but without limitation, a network 108 may be a local area network (LAN), such as an Ethernet network, a wide area network (WAN), a virtual network such as but not limited to a virtual private network (VPN), the Internet, an intranet, an extranet, a public switched telephone network (PSTN), a wireless network such as but not limited to a cellular telephony network or a network operating under any one of the IEEE 802.11 suite of protocols, the Bluetooth protocol or any other wireless or wireline protocol. Moreover, the network 108 can include a number of networks of different types and/or utilizing different protocols. Accordingly, the network 108 can be any network or system operable to allow communications or exchanges of data between communication devices 104 directly, via the virtual reality server 112, the conference server 114, and/or a communication or other server or network node.

A VR server 112 generally comprises a server computer connected to the network 108 that is operable to provide a hosted VRE to users 116 of communication devices 104. More particularly, a VRE module 120 can be executed by the VR server 112 to provide a VRE. Moreover, a single VR server 112 can be capable of providing multiple VREs.

The VRE module 120 running on the virtual reality server 112 generally operates to provide a virtual reality environment to registered communication devices 104, such that users 116 of the communication devices 104 can interact through the virtual reality environment. Moreover, the virtual reality server 112 disclosed herein can operate to provide a virtual reality environment to communication devices 104 that are registered with an MCU conference module 128 running on an MCU 124, where the MCU conference module 124 is in turn registered with the VRE module 120. In general, the virtual reality module 120 operates to present the virtual reality environment to users 116 through communication devices 104 participating in a virtual reality environment. Moreover, the virtual reality environment is controlled by the virtual reality module 120 with respect to each communication device 104 participating in a virtual reality session. Through a connection between the VRE module 120 on the VR server 112 and the communication device 104, shared virtual reality information is presented to all users 116 participating in the virtual reality session. In addition, the VRE module 120 can selectively present individual users 116 with information according to the viewpoint of an associated avatar in the virtual reality environment, or other controls.

The optional conference server or MCU 124 also generally comprises a server computer connected to the network 108. The MCU 124 can provide registration services for multipoint conferences conducted within or in association with a VRE hosted by a VR server 112. A multipoint conference service can be provided in connection with the execution of an MCU module 128 by the MCU 124. In accordance with other embodiments of the present disclosure, the functions of an MCU can be provided by the VR server 112 itself. For example, a VR server 112 can execute an MCU module 128. As another example, multipoint conference services can be provided as a function of a VRE module 120.

The MCU conference module 128 generally operates to interconnect registered communication devices 104 with one another, to provide a multipoint conference facility. For example, audio/video streams can be exchanged between the participants of a conference established through the MCU conference module 128. Although the MCU conference module 128 can present both audio and video information to participating users 116 through associated communication devices 104, the MCU conference module 128 does not itself provide a virtual reality environment in which users 116 are depicted as avatars, and in which interactions between users 116 can be controlled, at least in part, through manipulation of the avatars. Instead, as described herein, a virtual reality environment can be extended to users 116 that are first registered with the MCU conference module 128 by a VRE module 120.

In operation, users 116 interact within a VRE provided by a VR server 112 to which the communication devices 104 of the participating users 116 are connected via the network 108. More particularly, at least some of the communication devices 104 participate in a VRE provided by a VRE module 120 running on the VR server 112 hosting the VRE through a registration of such communication devices 104 with the VRE module 120, and to other communication devices 104 that are connected to the VRE module 120. Participation in a VRE can require registration with the VR server 112 and/or the hosted VRE, and/or through a registration with an MCU conference module 128 running on the VR server 112 and/or an associated conference server or MCU 124. For example, an MCU conference module 128 can register with the VRE module 120, and the MCU conference module 128 extends the VRE provided by the VRE module 120 to those communication devices 104 registered with the MCU conference module 128. In an exemplary embodiment, a communication endpoint 104 is capable of providing visual information depicting a virtual reality environment to a user 116. Accordingly, a user 116 can interact with other users through avatars visually depicted within a shared VRE.

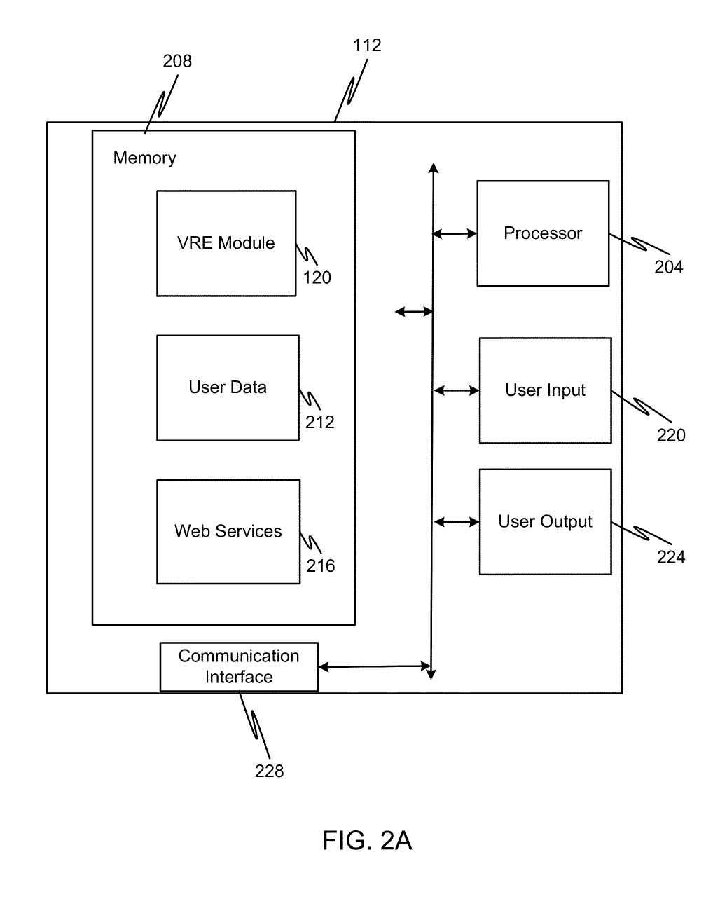

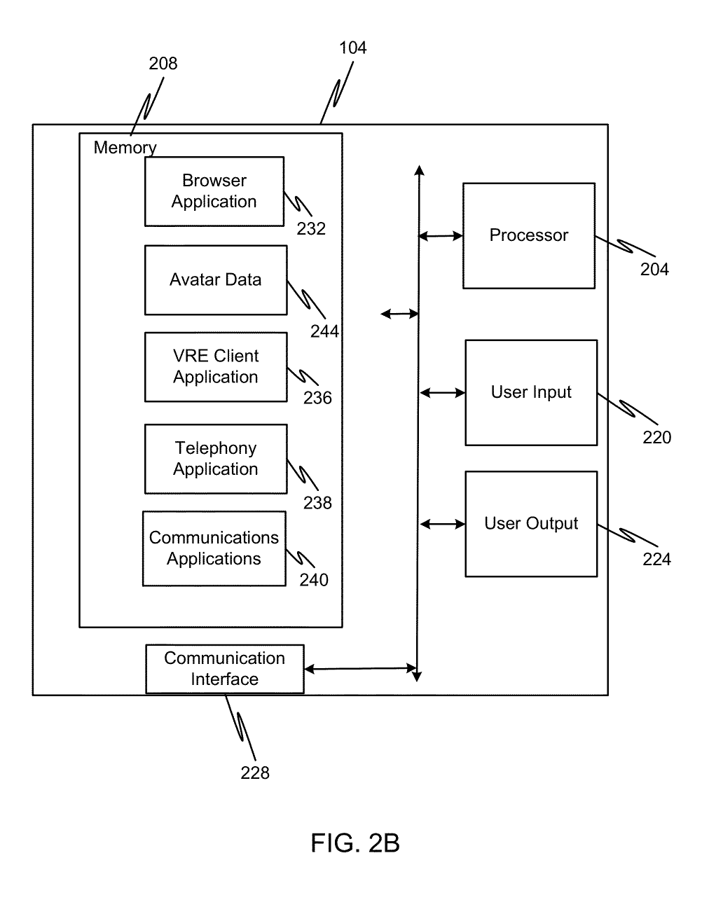

FIGS. 2A-2B are block diagrams depicting components of a virtual reality server 112, and of a communication device 104 respectively in accordance with embodiments of the present disclosure. The virtual reality server 112, and the communication device 104 each can include a processor 204 capable of executing program instructions. The processor 204 can include any general purpose programmable processor or controller for executing application programming. Alternatively, the processor 204 may comprise a specially configured application specific integrated circuit (ASIC). The processor 204 generally functions to run programming code implementing various functions performed by the associated server or device. For example, the processor 204 of the VR server 112 can implement functions performed in connection with the presentation of a virtual reality environment to users 116 of communication devices 104 through execution of the virtual reality module 120. The processor of a communication device 104 can operate to present audio/video information to a user 116 through execution of a browser application 232, a VRE client application 236, a telephony application 238, including but not limited to a video telephony application, or some other communication application 240. In addition, the processor of a communication device can operate to provide avatar data 244 to a VRE module 120.

The virtual reality server 112, and the communication device 104 additionally include memory 208. The memory 208 can be used in connection with the execution of programming by the processor 204, and for the temporary or long term storage of data and/or program instructions. For example, the virtual reality server 112 memory 208 can include an application implementing the virtual reality environment module 120, stored user data 212, and a web services module 216 that can operate in connection with the VR module 120 to present information to communication devices 104 participating in a VRE. The memory 208 of a communication device 104 can include a browser application 232, a VRE client application 236, a telephony application 238, various communication applications 240 and avatar data 244. The memory of a server 112 or device 104 can include solid state memory that is resident, removable and/or remote in nature, such as DRAM and SDRAM. Moreover, the memory 208 can include a plurality of discrete components of different types and/or a plurality of logical partitions. In accordance with still other embodiments, the memory 208 comprises a non-transitory computer readable storage medium. Such a medium may take many forms, including but not limited to non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read.

The VR server 112, and a communication device 104 can also include or be associated with user input devices 220 and user output devices 224. Such devices 220 and 224 can be used in connection with the provisioning and operation of a VRE, a conventional multipoint conference, and/or to allow users to control operations of the VRE, conventional conference, and/or the display of and interaction with VRE and/or conference information. Examples of user input devices 220 include a keyboard, a numeric keypad, a touch screen, a microphone, scanner, and pointing device combined with a screen or other position encoder. Examples of user output devices 224 include a display, a touch screen display, a speaker, and a printer. The VR server 112, conference server 114, and a communication device 104 also generally include a communication interface 228 to interconnect the associated server 112 or device 104 to a network 108.

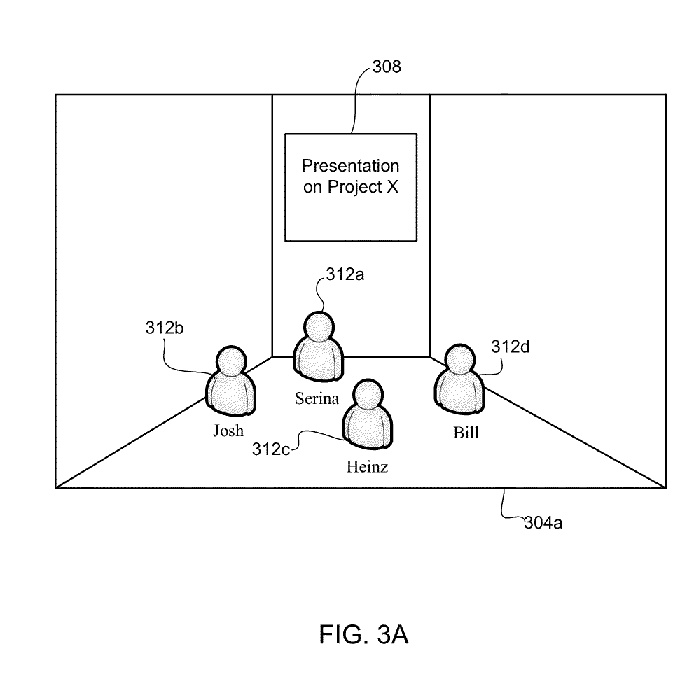

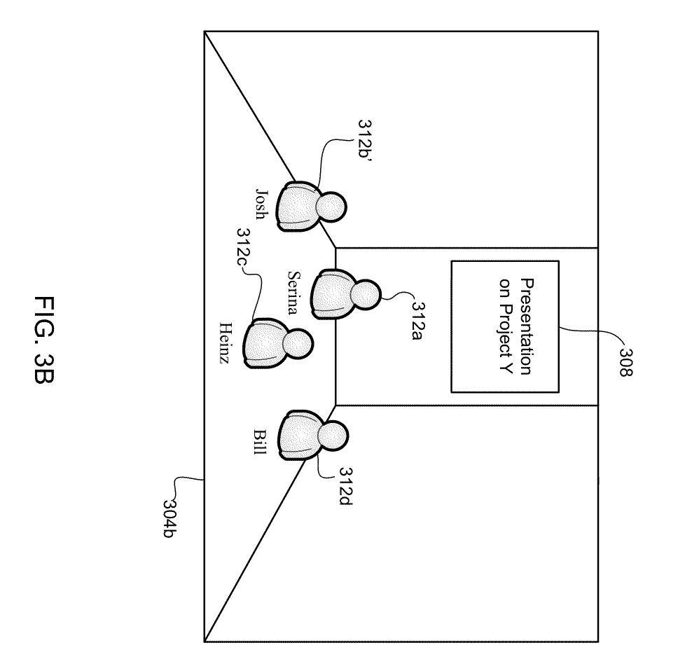

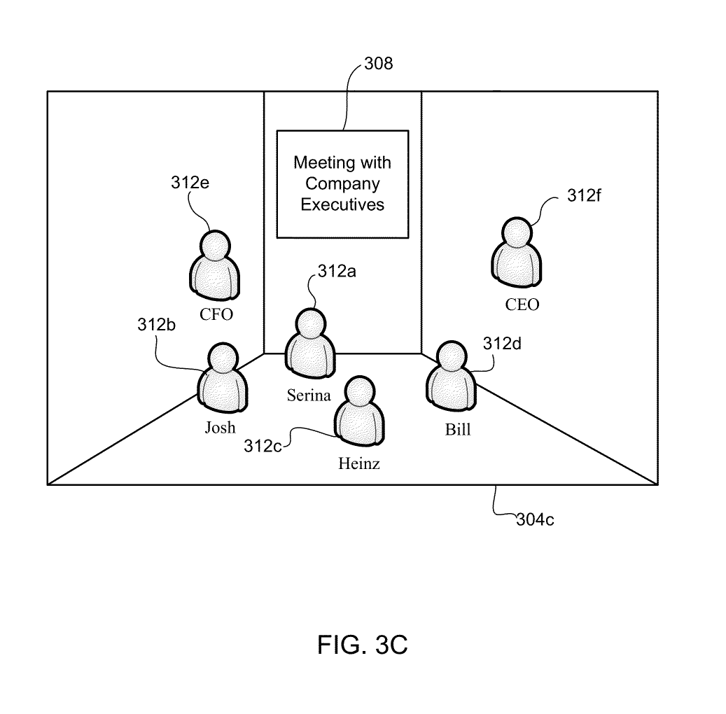

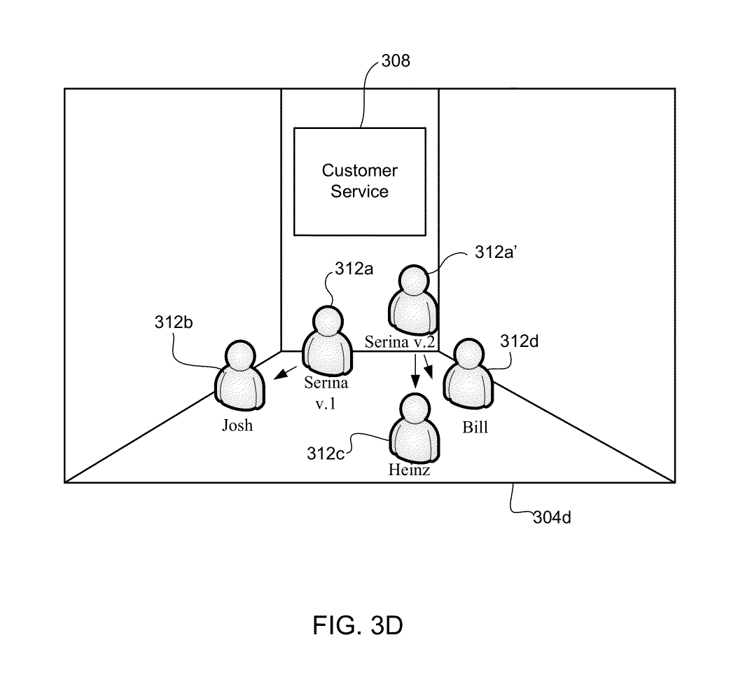

FIGS. 3A-3D depict exemplary interactive environments or VREs 304 as presented to a user 116 participating in a VRE hosted by a VR server 112 in accordance with embodiments of the present disclosure. The VREs 304 can be presented by or in connection with a user output device 224 (e.g., a display) of a communication device 104. The VREs 304 can be generated through or in connection with the operation of the VR module 120 running on the VR server 112, and/or in connection with a companion application, such as a browser application 232 and/or a VRE client application 236, running on the communication device 104 that together with the communication device 104 user input 220 devices and user output devices 224 presents a user interface through which the user 116 can interact with the VRE 304.

In the VREs 304 the users 116 of communication devices 104 participating in a VR meeting or other event conducted in connection with the VRE 304 are depicted as avatars 312. The avatars 312 can include avatars depicting users 116 associated with communication devices 104 that have registered with the VRE module 120 directly. In addition, embodiments of the present disclosure allow users 116 who have registered with an MCU conference module 124a as part of a multipoint conference established through a conference server 114 to participate in the VRE 304. For example, as shown in FIG. 3A, the first 312a, second 312b, third 312c, and fourth 312d avatars may depict the first 116a, second 116b, third 116c, and fourth 116d users associated with the first 104a, second 104b, third 104c, and fourth 104d communication devices respectively. Accordingly, in the VRE 304a of that figure, each registered user 116 of a communication device 104 participating in the VRE 304a is depicted as or by a separate avatar 312.

Whether a user 116 is registered with the VRE module 120 directly, or through the MCU conference module 124, the experience of the VRE 304 can be the same. Accordingly, the view of the VRE 304 presented by the user interface can provide the same user experience to all participants. Accordingly, the VRE 304 can operate such that audio and/or video information provided to the VRE is available to all users 116, provided the avatar 312 is located and/or controlled to receive that information. For example, where the first avatar 312a represents the presenter, the users 116 associated with the remaining avatars 312b-d, can see the presentation materials provided as the displayed information 308, as well as hear an audio stream comprising a narration from the presenter. In addition, the avatars 312 can be controlled to access and/or provide information selectively. For instance, by placing the second 312b and third 312c avatars in close proximity to one another, the users 116 associated with those avatars can engage in a side bar conversation or exchange of information. Moreover, in the composite environment provided by the VRE 304 of embodiments of the present disclosure, such control is provided and/or features are available to all users 116 participating in the VRE 304.

In accordance with embodiments of the present disclosure, the characteristics of a user's 116 avatar 312 can be defined prior to application of the avatar 312 to a particular VRE 304. For instance, the characteristics of an avatar 312 associated with a user 116 can be stored as avatar data 244 in the memory 208 of the user's 116 communication device 104. Moreover, as described in greater detail elsewhere herein, different avatars 312 can be defined and maintained as part of avatar data 244 for application by the user 116 in different VREs 304. In addition, avatar augmentation materials can be stored in avatar data 244 for association with one or more of a user's avatars 312. Avatar augmentation materials include, but are not limited to, presentations, documents, business cards, media, data files or any other material that can be stored as or in an electronic file or data.

With reference now to FIG. 3B, a VRE 304b in accordance with a further example is depicted. More particularly, the VRE 304b is similar to the VRE 304a, except that the displayed information 308 and/or the topic of the meeting hosted within the VRE is different. In addition, although the roster of participants 116, as represented by their avatars 312, are the same in the different VREs 304, one or more of the avatars 312 may be different in the different VREs 304. For example, a second user 116b may be associated with a second avatar 312b′ with a set of characteristics that is different than the set of characteristics associated with the second avatar 312b in the first example. Moreover, the selection of an avatar 312b′ with a different set of characteristics can be made at the direction of the user 116b. Alternatively, the selection of an avatar 312 with a different set of characteristics can be performed automatically, for instance in response to the different meeting topic for the meeting hosted in the second VRE 304b. As a further example, the VRE 304b may be implemented using a different VR server 112. For instance, while the first VRE 304a might be implemented by the first VR server 112a, the second VRE 304b might be implemented by the second VR server 112b. Moreover, the different VR servers 112 and/or associated VR module 120 may present different computing environments, necessitating the use of an avatar 312 in the first VRE 304a that is formatted differently than an avatar applied in the second VRE 304b. In such a case, the two avatars 312b and 312b′ may present identical characteristics to other users 116, but differ only in their formatting or coding to comply with the different computing environments. As still another example, presence information can be applied to influence the set of characteristics of a selected avatar. For instance, a user 116 at a cold location might be depicted by an avatar 312 as being dressed in a sweater, while a user 116 at a warm location might be depicted by an avatar 312 as being dressed in shorts.

The different avatar 312 characteristics can include characteristics related to the appearance of the avatar 312. For instance, if the first VRE 304a is related to a presentation 308 directed to the financial performance of an enterprise, and the user 116b might choose an avatar 312b depicted as being dressed in a suit and tie. If the second VRE 304b is related to a presentation 308 directed to a company team building exercise, the user 116b might choose an avatar 312b′ depicted as being dressed in shorts and a shirt with a company logo. As another example, some or all of the avatar 312 characteristics can be selected as a result of the particular VRE 304 in which the avatar 312 is depicted. For instance, the different clothing selections described above could be made as a result of the enforcement of rules for the different VREs 304 by the VR module 120. Such rules can be established by the moderator or organizer of the VRE 304 (e.g., dress code rules) or the individual user 116 (e.g., select avatar based on VR meeting topics).

With reference now to FIG. 3C, in accordance with other embodiments, the avatar 312 and/or avatar 312 characteristics applied by a user 116 in connection with a VRE 304 can be determined with reference to the identity of one or more other users 116 participating in the VRE 304. For example, if a user 116 is participating in a VRE 304c hosting a meeting with company executives, information about the participation of the company executives 312e and 312f in the VRE 304c can influence the characteristics of the selected avatar 312. For example, the characteristics presented by an avatar 312 formatted for compatibility with the VRE 304c can be selected. In accordance with other embodiments, a different avatar 312 can be selected for application to the VRE 304c as a result of the presence of the company executives, as compared to a VRE 304 in which company executives are not present. Moreover, such a change can be made mid-meeting, for example if the roster of participants changes during the meeting.

In accordance with still other embodiments, the characteristics of an avatar 312 can be presented to other participants within a VRE 304 differently, depending on characteristics of the other participants. For example, as depicted in FIG. 3D, an avatar 312a comprising a first set of characteristics related to a first user 112a can be presented to a second user 312b, while an alternate avatar 312a′ can be presented to third 116c and 116d users associated with third 312c and further 312d avatars respectively. The selection of either the first avatar 312a or the first alternate avatar 312a′ for presentation to another participant in the VRE 304d can be made with reference to the characteristics of those other users 116b, 116c, or 116d, and/or the characteristics of the other users' avatars 312b, 312c, and 312d. For instance, the physical characteristics presented by the selected avatar 312a or 312a′ can be those that are determined to provide the highest level of comfort or affinity to the other participant to which the selected avatar 312a or 312a′ is presented. As an example, in a customer service VRE 304d, the avatar 312a selected to represent a customer service representative or agent 116a may depict a female to the other participant 116b. As yet another example, the selected avatar 312a′ may depict the agent 116a as wearing glasses to other participants 116c and 116d associated with avatars 312c and 312d. Moreover, an avatar 312 may present a first set of characteristics to some users 116 while presenting a second set of characteristics to other users 116 simultaneously.

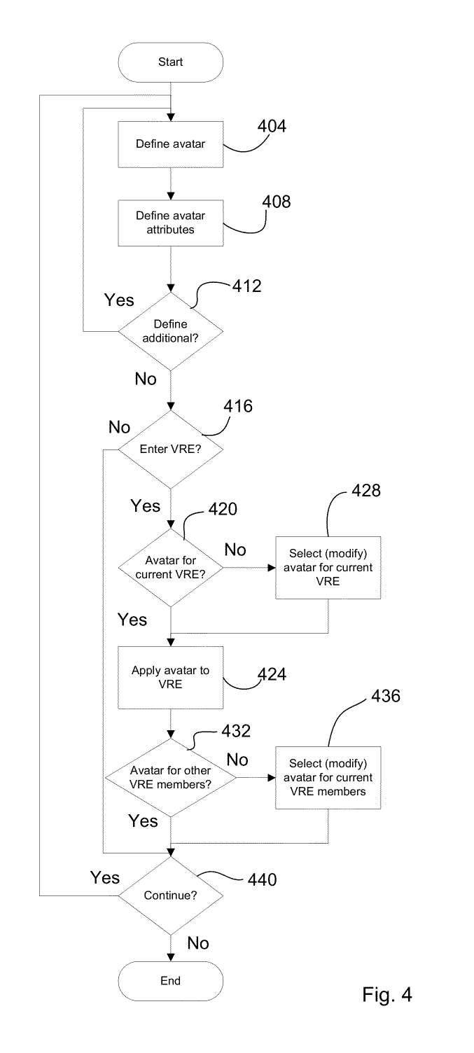

With reference now to FIG. 4, aspects of a method for presenting conference information within a virtual reality environment are depicted. Initially, at step 404, an avatar 312 is defined for a user 116. Defining an avatar 312 can include initiating the creation of an avatar 312 for use in connection with a particular VRE module 120 and/or VRE 304. At step 308, a set of attributes or characteristics of the avatar 312 are defined. The attributes of an avatar 312 can, for example but without limitation, include physical characteristics, such as the physical appearance of the user 116 associated with the avatar 312. Other exemplary characteristics or attributes of the avatar 312 that can be defined include, but are not limited to, a name, nickname, accent, gestures, or materials augmenting the avatar 312, such as virtual business cards, presentations, documents, or the like. A file or other collection of data defining the avatar 312 can be stored on the communication device 104 as avatar data 144. At step 412, a determination can be made as to whether an additional avatar 312 is to be defined. For example, a user 116 may wish to make an avatar 312 available to that user in different VREs 304 operating in connection with different VRE modules 120 and/or different VR servers 112, that require different formatting coding requirements. As yet another example, a user 116 may wish to define different avatars 312 having different attributes for application in different VREs 304. For instance, a first avatar 312 can be defined with a first set of attributes while a second avatar 312 can be defined with a second set of attributes. If additional avatars are to be defined, the process can return to step 404.

At step 416, a determination can be made as to whether a user 116 has entered a VRE 304. Entering a VRE 304 can include a user joining a conference through an MCU module 128, or directly entering a VRE 304 provided by a VRE module 120 at the initiation of a user 116, or through an invitation received by the user 116, for example through a communication device 104. If the user 116 has entered a VRE 304, a determination is made as to whether an avatar 312 for the current VRE 304 is available (step 420). If an avatar for the current VRE 304 exists, that avatar 312 is applied to the current VRE 304 (step 424). For example, the avatar 312 is added to the displayed group of avatars 312 included in the VRE 304. If an avatar 312 is not available for the current VRE 304, an avatar 312 for the current VRE 304 is created as an entirely new avatar, or as a modification of an existing avatar (step 428). For example, if an avatar 312 for a user 112 is available, but that available avatar 312 is formatted for use in connection with a VRE 304 hosted by a first VRE module 120, and the current VRE is a second VRE 304b hosted by a second VRE module 120b, the existing avatar 312 can be reformatted for compatibility with the second VRE module 120b. Reformatting the existing avatar 312 can include the VRE client application 236 in the communication device 104 of the user 116 taking avatar data 244 for the existing avatar 312, and reformatting that data. Accordingly, a translation of an avatar 312 for compatibility with different VRE modules 120 can be performed by the VRE client application 236. Alternatively or in addition, the creation of an avatar 312 for a current VRE 304 can include a modification to an existing avatar 312. For example, an avatar 312 that include features that are not supported by a current VRE 304 can be modified for compatibility with the current VRE 304. The created avatar 312 can then be selected for application to the current VRE 304.

In addition to compatibility with different VR modules 120, different avatars 312 can be selected for compatibility with the topics, other participants, or other considerations comprising the context of a VRE 304. Different avatars 312 can also be selected for compatibility with the different data format requirements of different VR modules 120. For example, as noted above, different avatar characteristics can be selected by an associated user 116 for different VREs 304. Alternatively or in addition, different characteristics can be applied through the application of rules that operate in consideration of the context of a VRE 304, including the topic of a hosted meeting, the identities of other participants 116, and the like. The rules may affect filters that remove certain defined characteristics, or that add certain characteristics, based on the VRE 304 of the users 116, etc. Accordingly, the characteristics or attributes of an avatar 312 representing a user 116 can be tailored to best represent that user 116 within a particular VRE 304 or context.

At step 432, a determination can be made as to whether an avatar 312 for other VRE 304 participants should be modified. In particular, embodiments of the present disclosure allow a user 116 to be provided with a depiction of another user 116, as represented by that other user's avatar 312, that are different than what is presented by that other user 116 to a third participating user 116. For instance, a user 116 who is presenting information to a group of other users 116 within a VRE 304 can be depicted to each of a plurality of other users 116 differently, such that the characteristics of the presenter represented to a first other user 116 are similar to those of the first other user 116, while the characteristics of the presenter represented to a second other user are like those of the second other user 116. Accordingly, the selection of characteristics can be made to develop an affinity between users 116 participating a VRE 304. If a determination is made that an avatar for other VRE participants should be modified, a modified avatar is selected, or an existing avatar 312 is modified, before being presented to the user (step 436). At step 440, a determination can be made as to whether the process should continue. If the process is to continue, it can return to step 404. Alternatively, the process can end.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for providing avatar characteristics, comprising:
defining a first set of characteristics of a first avatar associated with a first user, wherein the first set of characteristics affect at least one attribute of the first avatar;
applying the first set of characteristics to a first application of the first avatar in a first interactive computing environment;
applying at least a portion of the first set of characteristics to a second application of the first avatar in a second interactive computing environment, wherein the first set of characteristics are imported to the second interactive computing environment from at least one of the first interactive computing environment, a user computing environment, and a server computing environment.

2. The method of claim 1, wherein the first set of characteristics are imported to the first and second interactive computing environments from at least one of the user computing environment and the server computing environment.

3. The method of claim 2, wherein the first set of characteristics is stored in at least one of the user computing environment and the server computing environment in a first format.

4. The method of claim 3, wherein the first set of characteristics is altered for application to the first interactive computing environment when the first set of characteristics are imported to the first interactive computing environment.

5. The method of claim 4, wherein the alteration of the first set of characteristics is made in response to characteristics of a second user associated with the first interactive computing environment.

6. The method of claim 4, wherein the alteration of the first set of characteristics is made in response to a subject matter of the first interactive computing environment.

7. The method of claim 3, wherein the first format is translated into a second format that is compatible with the first interactive computing environment when the first set of characteristics are imported to the first interactive computing environment.

8. The method of claim 7, wherein the first format is translated into a third format that is compatible with the second interactive computing environment when the first set of characteristics are imported to the second interactive computing environment.

9. The method of claim 7, wherein the attributes of the first set of characteristics are altered to create a second set of characteristics as part of translating the first set of characteristics into the second format.

10. The method of claim 9, wherein the attributes of the first set of characteristics are altered to create a third set of characteristics as part of translating the first set of characteristics into the third format that is compatible with the second interactive computing environment, and wherein the first, second, and third sets of characteristics are different from one another.

11. The method of claim 7, wherein at least one of the second set of characteristics and the third set of characteristics is a subset of the first set of characteristics.

12. The method of claim 7, wherein the alteration of the first set of characteristics is a result of an application of an automated rule.

13. The method of claim 7, wherein the alteration of the first set of characteristics is a result of a manual entry by the user.

14. The method of claim 1, wherein the first set of characteristics includes an avatar appearance attribute and an avatar augmentation attribute.

15. The method of claim 1, further comprising:
defining a second set of characteristics of a second avatar associated with the first user, wherein the second set of characteristics affects at least one attribute of the second avatar;
applying the second set of characteristics to a first application of the second avatar in a third interactive computing environment, wherein the second avatar is selected for use in the third interactive computing environment in view of differences between the first and second sets of characteristics and in view of differences between the first and third interactive computing environments.

16. A system, comprising:
a user computer, including:
a user input device;
a user output device;
a communication interface;
memory:
a processor;
application programming stored in the memory and executed by the processor, wherein the application programming is operable to present a virtual reality environment to a user through the user output device and to receive control input from the user through the user input device, wherein the application programming is in communication with an interactive computing environment through the communication interface, and wherein the interactive computing environment includes at least a first avatar associated with the first user;
a first virtual reality environment (VRE), wherein the first VRE includes the first avatar, and wherein the first VRE is in communication with the user computer during at least a first time;
a second VRE, wherein the second VRE includes at least one of a modified version of the first avatar and a second avatar associated with the first user, and wherein the second VRE is in communication with the user computer during at least a second time.

17. The system of claim 16, wherein the first avatar is stored in the memory.

18. The system of claim 17, further comprising:
a first virtual reality (VR) server, wherein the first VRE is provided by the first VR server;
a second VR server, wherein the second VRE is provided by the second VR server.

19. A computer readable medium having stored thereon computer-executable instructions, the computer executable instructions causing a processor to execute a method for providing an avatar to a virtual reality environment (VRE), the computer readable instructions comprising:
instructions defining a first avatar associated with a first user having a first set of characteristics;
instructions defining a second avatar associated with the first user having a second set of characteristics;
instructions to select one of the first and second avatars in response to one of: a user selection, a subject of a meeting hosted by the VRE, an identity of another user participating in the VRE, or presence information.

20. The computer readable medium of claim 19, wherein the first avatar is presented to a second user in a first VRE, and wherein the second avatar is presented to a third user in the first VRE.
